(19) United States
(12) Patent Application Publication
(10) Pub. No.: US 2017/0269117 A1
(43) Pub. Date: Sep. 21, 2017

(54) ULTRASOUND WIND MEASUREMENT DEVICE AND METHOD

(71) Applicant: BEIJING ASINDATA TECHNOLOGY CO., LTD, Beijing (CN)

(72) Inventor: Xiaojing WANG, Beijing (CN)

(21) Appl. No.: 15/323,568

(22) PCT Filed: Apr. 29, 2015
(86) PCT No.: PCT/IB2015/053114

§ 371 Date: May 31, 2017

(30) Foreign Application Priority Data
Apr. 30, 2014 (CN) 201410178762.0

(51) Int. Cl. G01P 5/24; G01P 13/02

(52) U.S. Cl. CPC G01P 5/24; G01P 13/02

(57) ABSTRACT

The present disclosure provides an ultrasonic wind measurement device and an ultrasonic wind measurement method, so as to measure a wind speed and a wind direction in an environment using transmission characteristics of an ultrasonic wave. The ultrasonic wind measurement device includes: an ultrasonic transducer group configured to generate ultrasonic resonance in a wind measurement cavity receiving the ultrasonic transducer group; a transmission module configured to drive any ultrasonic transducer in the ultrasonic transducer group to transmit an ultrasonic wave; a transmission-reception conversion module configured to perform a link switching operation on the ultrasonic transducer group in accordance with a predetermined control command; a reception module configured to receive the ultrasonic wave; a collection module configured to acquire original data about the transmission and reception of the ultrasonic wave; an FPGA processing chip configured to process the original data so as to acquire time data; and a processor control module configured to acquire a current wind speed and a current wind direction through calculation in accordance with the time data. According to the present disclosure, due to a short ultrasonic transmission distance, it is able to ensure the measurement accuracy. In addition, due to a small volume, it is able to facilitate the installation of the ultrasonic wind measurement device.

### TECHNICAL FIELD

The present disclosure relates to the field of ultrasonic sensing technology, in particular to an ultrasonic wind measurement device and an ultrasonic wind measurement method.

### BACKGROUND

Along with the development of technologies, a measurement error may occur for a traditional mechanical (triangular cup- or vane-type) wind sensor due to inaccurate measurement, mechanical abrasion and sands attached thereto. Hence, devices for measuring a wind speed and a wind direction using a sensing technology (e.g., an ultrasonic sensing technology) have been presented. However, usually the device for the ultrasonic measurement of the wind speed and the wind direction includes four ultrasonic transducers, resulting in a large volume of the device and interference.

Hence, the conventional measurement device has such drawbacks as large volume, low measurement accuracy and low environmental adaptability.

### SUMMARY

An object of the present disclosure is to provide an ultrasonic wind measurement device and an ultrasonic wind measurement method, so as to overcome such drawbacks in the related art as large volume, low measurement accuracy and low environmental adaptability.

In one aspect, the present disclosure provides in some embodiments an ultrasonic wind measurement device, including: an ultrasonic transducer group consisting of a first ultrasonic transducer, a second ultrasonic transducer and a third ultrasonic transducer and configured to generate ultrasonic resonance in a wind measurement cavity receiving the ultrasonic transducer group; a transmission module configured to drive any ultrasonic transducer in the ultrasonic transducer group to transmit an ultrasonic wave; a transmission-reception conversion module configured to perform a link switching operation on the ultrasonic transducer group in accordance with a predetermined control command, so as to enable the ultrasonic transducer in a transmitting state to communicate with the transmission module and enable the ultrasonic transducer in a receiving state to communicate with a reception module; the reception module configured to receive the ultrasonic wave; a collection module configured to acquire original data about the transmission and reception of the ultrasonic wave; a Field Programmable Gate Array (FPGA) processing chip configured to generate a first driving signal for driving the transmission module to generate the ultrasonic wave, and to process the original data so as to acquire time data; and a processor control module configured to acquire an initialization parameter, and acquire a current wind speed and a current wind direction through calculation in accordance with the time data.

In a possible embodiment of the present disclosure, the predetermined control command includes: a command for disenabling a link between the transmission module and the first ultrasonic transducer, enabling a link between the transmission module and the second ultrasonic transducer, disenabling a link between the reception module and the second ultrasonic transducer and enabling a link between the reception module and the first ultrasonic transducer in the case that a time period for the link switching operation has reached a predetermined value; a command for controlling the first ultrasonic transducer and the third ultrasonic transducer to perform wave transmission, and controlling the first ultrasonic transducer and the third ultrasonic transducer to perform the link switching operation between the reception module and the transmission module, after the wave transmission from the first ultrasonic transducer to the second ultrasonic transducer and the wave transmission from the second ultrasonic transducer to the first ultrasonic transducer have been completed; and a command for controlling the second ultrasonic transducer and the third ultrasonic transducer to perform the wave transmission, and controlling the second ultrasonic transducer and the third ultrasonic transducer to perform the link switching operation between the reception module and the transmission module, after the wave transmission from the first ultrasonic transducer to the third ultrasonic transducer and the wave transmission from the third ultrasonic transducer to the first ultrasonic transducer have been completed.

In a possible embodiment of the present disclosure, the ultrasonic wind measurement device further includes a self-adaptive heating module configured to compare a current ambient temperature with a predetermined temperature to acquire a comparison result, and adjusting heating power of a corresponding heating device in accordance with the comparison result.

In a possible embodiment of the present disclosure, the ultrasonic wind measurement device further includes an encryption module configured to initially authenticate the ultrasonic wind measurement device, and after the authentication has succeeded, control the processor control module to read the initialization parameter.

In a possible embodiment of the present disclosure, the processor control module is further configured to: calculate a resonant frequency in accordance with a predetermined environmental compensation parameter and a distance between two planes in the wind measurement cavity; compare the resonant frequency with a current frequency of the ultrasonic wave, so as to acquire a comparison result; in the case that the comparison result indicates that a difference between the resonant frequency and the current frequency of the ultrasonic wave is greater than a predetermined threshold, determine whether or not the resonant frequency falls within an operating frequency range of the ultrasonic transducer group; and in the case that the resonant frequency falls within the operating frequency range of the ultrasonic transducer group, adjust a transmission frequency of the ultrasonic transducer group, so as to enable the ultrasonic wave to generate the resonance in the wind measurement cavity.

In another aspect, the present disclosure provides in some embodiments an ultrasonic wind measurement method for an ultrasonic wind measurement device which includes an ultrasonic transducer group consisting of a first ultrasonic transducer, a second ultrasonic transducer and a third ultrasonic transducer, the ultrasonic wind measurement method including steps of: triggering any ultrasonic transducer in the ultrasonic transducer group to transmit a predetermined ultrasonic wave; controlling the predetermined ultrasonic wave to generate resonance in a wind measurement cavity receiving the ultrasonic transducer group, so as to enable any two ultrasonic transducers in the ultrasonic transducer group to be in a transmitting state and a receiving state within an identical time period respectively; acquiring a first direction transmission time period and a second direction transmission time period of the waves between the two ultrasonic transducers; and calculating a current wind speed and a current wind direction in accordance with the first direction transmission time period and the second direction transmission time period.

In a possible embodiment of the present disclosure, the step of triggering any ultrasonic transducer in the ultrasonic transducer group to transmit the predetermined ultrasonic wave includes: controlling an FPGA processing chip to generate a predetermined frequency in accordance with a predetermined parameter; and controlling a transmission module to transmit the predetermined ultrasonic wave in accordance with the predetermined frequency and the number of waves in the predetermined parameter.

In a possible embodiment of the present disclosure, the step of controlling the predetermined ultrasonic wave to generate the resonance in the wind measurement cavity receiving the ultrasonic transducer includes performing a link switching operation on the ultrasonic transducers in the ultrasonic transducer group in accordance with a predetermined control rule, so as to enable the ultrasonic transducer in the transmitting state to communicate with the transmission module and enable the ultrasonic transducer in the receiving state to communicate with the reception module.

In a possible embodiment of the present disclosure, the predetermined control rule includes: disenabling a link between the transmission module and the first ultrasonic transducer, enabling a link between the transmission module and the second ultrasonic transducer, disenabling a link between the reception module and the second ultrasonic transducer and enabling a link between the reception module and the first ultrasonic transducer in the case that a time period for the link switching operation has reached a predetermined value; controlling the first ultrasonic transducer and the third ultrasonic transducer to perform wave transmission, and controlling the first ultrasonic transducer and the third ultrasonic transducer to perform the link switching operation between the reception module and the transmission module, after the wave transmission from the first ultrasonic transducer to the second ultrasonic transducer and the wave transmission from the second ultrasonic transducer to the first ultrasonic transducer have been completed; and controlling the second ultrasonic transducer and the third ultrasonic transducer to perform the wave transmission, and controlling the second ultrasonic transducer and the third ultrasonic transducer to perform the link switching operation between the reception module and the transmission module, after the wave transmission from the first ultrasonic transducer to the third ultrasonic transducer and the wave transmission from the third ultrasonic transducer to the first ultrasonic transducer have been completed.

In a possible embodiment of the present disclosure, subsequent to the step of calculating the current wind speed and the current wind direction in accordance with the first direction transmission time period and the second direction transmission time period, the ultrasonic wind measurement method further includes: calculating a resonant frequency in accordance with a predetermined environmental compensation parameter and a distance between two planes in the wind measurement cavity; comparing the resonant frequency with a current frequency of the ultrasonic wave, so as to acquire a comparison result; in the case that the comparison result indicates that a difference between the resonant frequency and the current frequency of the ultrasonic wave is greater than a predetermined threshold, determining whether or not the resonant frequency falls within an operating frequency range of the ultrasonic transducer group; and in the case that the resonant frequency falls within the operating frequency range of the ultrasonic transducer group, adjusting a transmission frequency of the ultrasonic transducer group, so as to enable the ultrasonic wave to generate the resonance in the wind measurement cavity.

According to the embodiments of the present disclosure, the ultrasonic wave may generate resonance in the wind measurement cavity due to transmission characteristics and a reflection principle thereof, so as to adjust the transmission power of the ultrasonic transducer. In addition, the resonant frequency may be adjusted in a self-adaptive manner using a self-adaptive algorithm, so as to enable the ultrasonic wind measurement device to operate in a resonant state in different environments.

### BRIEF DESCRIPTION OF THE DRAWINGS

The following drawings are provided to facilitate the understanding of the present disclosure, and constitute a portion of the description. These drawings and the following embodiments are for illustrative purposes only, but shall not be construed as limiting the present disclosure. In these drawings:

FIG. 1 is a schematic view showing an ultrasonic wind measurement device according to a first embodiment of the present disclosure;

FIG. 2 is a flow chart showing an operation procedure of a self-adaptive heating module according to the first embodiment of the present disclosure;

FIG. 3 is a flow chart of an ultrasonic wind measurement method according to a second embodiment of the present disclosure;

FIG. 4 is a flow chart of a self-adaptive resonance procedure in the ultrasonic wind measurement method according to a third embodiment of the present disclosure; and

FIG. 5 is a flow chart of a self-adaptive adjustment procedure of a transmission frequency in the ultrasonic wind measurement method according to a fourth embodiment of the present disclosure.

### DETAILED DESCRIPTION OF THE EMBODIMENTS

The present disclosure will be described hereinafter in conjunction with the drawings and embodiments, but various implementations defined and covered by the appended claims may also be applicable.

### First Embodiment

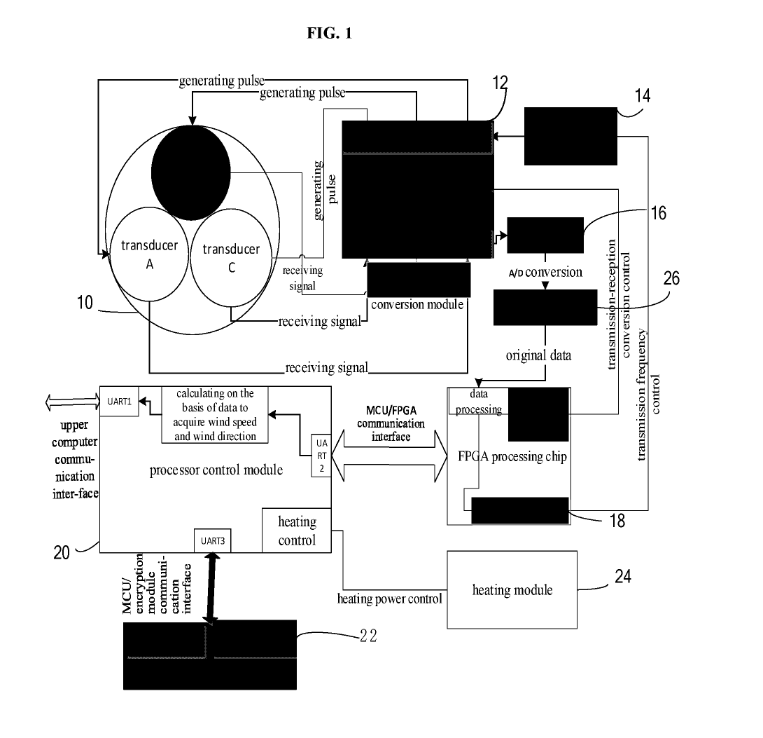

FIG. 1 is a schematic view showing an ultrasonic wind measurement device according to the first embodiment of the present disclosure.

As shown in FIG. 1, the ultrasonic wind measurement device includes: an ultrasonic transducer group 10 consisting of a first ultrasonic transducer A, a second ultrasonic transducer B and a third ultrasonic transducer C and configured to generate ultrasonic resonance in a wind measurement cavity (not shown) receiving the ultrasonic transducer group; a transmission module 14 configured to drive any ultrasonic transducer in the ultrasonic transducer group 10 to transmit an ultrasonic wave; a transmission-reception conversion module 12 consisting of a conversion module A, a conversion module B and a conversion module C and configured to perform a link switching operation on the ultrasonic transducer group 10 in accordance with a predetermined control command, so as to enable the ultrasonic transducer in a transmitting state to communicate with the transmission module 14 and enable the ultrasonic transducer in a receiving state to communicate with a reception module 16; the reception module 16 configured to receive the ultrasonic wave; a collection module 26 configured to acquire original data about the transmission and reception of the ultrasonic wave; an FPGA processing chip 18 configured to generate a first driving signal for driving the transmission module 14 to generate the ultrasonic wave, and to process the original data so as to acquire time data; and a processor control module 20 configured to acquire an initialization parameter, and acquire a current wind speed and a current wind direction through calculation in accordance with the time data.

To be specific, the ultrasonic wind measurement device may be used to achieve the conversion between high-frequency sound energy and electric energy through a direct piezoelectric effect and an inverse piezoelectric effect, thereby to transmit and receive an ultrasonic wave. In the case that projection components of the wind speed in a two-dimensional coordinate system are v_{y} and v_{y} , a speed of the ultrasonic wave transmitted in still air is c and a time period for the ultrasonic wave from an origin to an equipotential surface (x, y, z) is t, there is the following equation:

(x−vₓt)²+(y−v_{y}t)²=c²t² (1)

Ultrasonic sensors each having a transmitting function and a receiving function may be arranged at a point A′ (0, 0) and a point B′ (d, 0) spaced apart from the point A′ by a distance of d on an x-axis respectively. The ultrasonic wave from the ultrasonic sensor at the point A′ may be received by the ultrasonic sensor at the point B′, and then the ultrasonic wave from the ultrasonic sensor at the point B′ may be received by the ultrasonic sensor at the point A′. It is presumed that a direction from the point A′ to the point B′ is an along-wind direction. At this time, a time period for the ultrasonic wave from the point A′ to the point B′ may be calculated through the following equation:

$${t}_{1} = \frac{d [ {( {c}^{2} - {v}_{y}^{2} )}^{1 / 2} - {v}_{x} ]}{{c}^{2} - {v}^{2}} . \qquad ( 2 )$$

Identically, a time period for the ultrasonic wave from the point B′ to the point A′ may be calculated through the following equation:

$${t}_{2} = \frac{d [ {( {c}^{2} - {v}_{y}^{2} )}^{1 / 2} + {v}_{x} ]}{{c}^{2} - {v}^{2}} . \qquad ( 3 )$$

Based on t₁ and t₂, the projection component vₓ of the wind speed may be calculated through the following equation:

$${v}_{x} = \frac{d}{2} ( \frac{1}{{t}_{1}} - \frac{1}{{t}_{2}} ) = \frac{d ( {t}_{2} - {t}_{1} )}{2 {t}_{1} {t}_{2}} = \frac{d Δ t}{2 {t}_{1} {t}_{2}} . \qquad ( 4 )$$

As can be seen from the above equation (4), the component vₓ of the wind speed along the x-axis may be calculated in accordance with the time period t₁ in the along-wind direction, the time period t₂, in an against-wind direction and a difference Δt between the time periods. The projection component v_{y} along a y-axis of the rectangular coordinate system may be calculated in a similar manner. Finally, a wind speed v and a wind angle θ of the natural wind in the rectangular coordinate system may be calculated through the following equations:

$$\begin{matrix}v = {( {v}_{x}^{2} - {v}_{y}^{2} )}^{1 / 2} and & ( 5 ) \\ θ = {tan}^{- 1} ( {v}_{x} / {v}_{y} ) . & ( 6 )\end{matrix}$$

In the above equation (4), no speed c of the ultrasonic wave is contained, so it is able to prevent the measurement accuracy from being adversely affected by the temperature. However, at this time, the measurement accuracy of the time periods, especially a value of Δt, is highly demanded. In the case that the measurement accuracy of the wind speed is 0.15 m/s, the measurement accuracy of t₁ and t₂ needs to be 3.09 us, and the measurement accuracy oft needs to be 0.55 us. Hence, a key point for the ultrasonic wind measurement device just lies in the measurement accuracy of the time periods. In this regard, the FPGA processing chip having a clock rate of 100 MHz may be adopted by the ultrasonic wind measurement device, so as to achieve an error smaller than 10 ns in the time periods for the transmission module and the reception module. In addition, the received wave may be modified and compensated by the FPGA processing chip 18, so as to prevent the wave from being distorted due to external interference, thereby to improve the measurement accuracy.

In a word, according to the embodiments of the present disclosure, the ultrasonic wave may generate resonance in the wind measurement cavity due to transmission characteristics and a reflection principle thereof, so as to adjust the transmission power of the ultrasonic transducer. In addition, the resonant frequency may be adjusted in a self-adaptive manner using a self-adaptive algorithm, so as to enable the ultrasonic wind measurement device to operate in a resonant state in different environments.

In a possible embodiment of the present disclosure, the predetermined control command may include: a command for disenabling a link between the transmission module 14 and the first ultrasonic transducer A, enabling a link between the transmission module 14 and the second ultrasonic transducer B, disenabling a link between the reception module 16 and the second ultrasonic transducer B and enabling a link between the reception module 16 and the first ultrasonic transducer A in the case that a time period for the link switching operation has reached a predetermined value; a command for controlling the first ultrasonic transducer A and the third ultrasonic transducer C to perform wave transmission, and controlling the first ultrasonic transducer A and the third ultrasonic transducer C to perform the link switching operation between the reception module 16 and the transmission module 14, after the wave transmission from the first ultrasonic transducer A to the second ultrasonic transducer B and the wave transmission from the second ultrasonic transducer B to the first ultrasonic transducer A have been completed; and a command for controlling the second ultrasonic transducer B and the third ultrasonic transducer C to perform the wave transmission, and controlling the second ultrasonic transducer B and the third ultrasonic transducer C to perform the link switching operation between the reception module 16 and the transmission module 14, after the wave transmission from the first ultrasonic transducer A to the third ultrasonic transducer C and the wave transmission from the third ultrasonic transducer C to the first ultrasonic transducer A have been completed.

In a possible embodiment of the present disclosure, the processor control module 20 may be further configured to: calculate a resonant frequency in accordance with a predetermined environmental compensation parameter and a distance between two planes in the wind measurement cavity; compare the resonant frequency with a current frequency of the ultrasonic wave, so as to acquire a comparison result; in the case that the comparison result indicates that a difference between the resonant frequency and the current frequency of the ultrasonic wave is greater than a predetermined threshold, determine whether or not the resonant frequency falls within an operating frequency range of the ultrasonic transducer group 10; and in the case that the resonant frequency falls within the operating frequency range of the ultrasonic transducer group 10, adjust a transmission frequency of the ultrasonic transducer group 10, so as to enable the ultrasonic wave to generate the resonance in the wind measurement cavity.

To be specific, the processor control module 20 may take charge of validating an encryption module 22 in the case that it has been started. In the case that no abnormality occurs, the processor control module 20 may read parameters in the encryption module 22, initialize processor control parameters, and transmit parts of the initialized processor control parameters to the FPGA processing chip 18, so as to initialize parameters of the FPGA processing chip 18. In addition, the processor control module 20 may further take charge of performing calculation on the basis of data processed by the FPGA processing chip 18, so as to acquire the wind speed, the wind direction and a wind temperature.

The processor control module 20 may further take charge of performing heating power control calculation in accordance with the wind temperature, and controlling heating power of a heating module 24 in accordance with a calculation result.

The processor control module 20 may further take charge of communicating with an upper computer, the encryption module 22 and the FPGA processing chip 18, and processing commands from the upper computer.

The FPGA processing chip 18 may take charge of controlling the generation of the transmission frequency of each ultrasonic transducer, controlling a transmission interval, controlling a start time point of the reception module 16, and controlling the transmission function and the reception function of each ultrasonic transducer. In addition, the FPGA processing chip 18 may control in real time the conversion operation of the transmission-reception conversion module 12, so as to ensure that, for the three ultrasonic transducers, merely one ultrasonic transducer transmits the ultrasonic wave and merely one ultrasonic transducer receives the ultrasonic wave within each time period.

The FPGA processing chip 18 also needs to process the collected data, and it is further provided with a timer function so as to record the transmission time period of the ultrasonic wave. The FPGA processing chip 18 is further configured to compensate for and calibrate the transmission time period of the ultrasonic wave so as to collect the data in a more accurate manner, thereby to remarkably improve the measurement accuracy of the ultrasonic wind measurement device. In addition, the FPGA processing chip 18 is further configured to transmit the data to the processor control module via a communication interface.

The heating module 24, i.e., the self-adaptive heating module, may take charge of performing heating power control calculation in accordance with an ambient temperature, and adjusting the heating power in accordance with a calculation result, so as to enable the ultrasonic wind measurement device to be at a constant temperature, thereby to enable the ultrasonic wind measurement device to operate at a severe cold region.

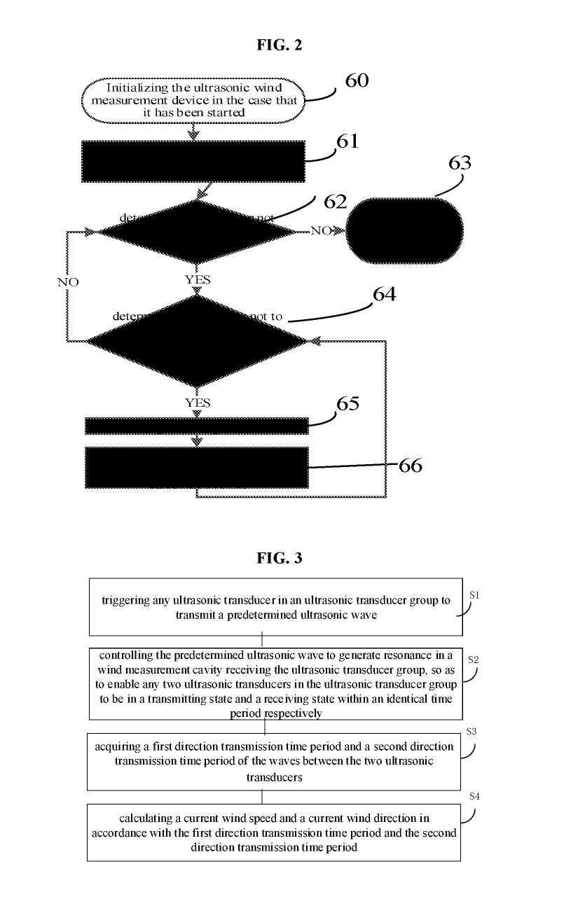

FIG. 2 is a flow chart of an operation procedure of the self-adaptive heating module according to the first embodiment of the present disclosure.

As shown in FIG. 2, the operation procedure of the self-adaptive heating module may include the following steps.

Step 60: initializing the ultrasonic wind measurement device in the case that it has been started.

Step 61: setting default heating power in accordance with the parameters.

After the initialization of the ultrasonic wind measurement device, the self-adaptive heating module may perform the heating operation in accordance with predetermined heating power (usually 0) set in a Random Access Memory (RAM), and upon the reception of the processed data from the FPGA processing chip, a Micro Control Unit (MCU) may calculate the wind speed and the wind direction in accordance with the basic principle for the ultrasonic wind measurement, and then adjust the heating power. There is the following relationship between the speed of the ultrasonic wave in air and the temperature: v=331.45+0. 607T, where T represents an actual temperature (□), and v represents a current speed of the ultrasonic wave (m/s).

The wind temperature at a current wind speed may be calculated in accordance with the above equation (1), the wind speed and the wind direction calculated by the MCU, and the parameters stored in the RAM.

Step 62: determining whether or not a heating function needs to be enabled, and in the case that the heating function does not need to be enabled, proceeding to Step 63.

Step 63: disenabling the heating function.

The MCU may determine whether or not the heating function needs to be enabled in accordance with a temperature threshold stored in the RAM at which the heating function needs to be enabled. In the case that the heating function does not need to be enabled, the heating power may be set as 0, and in the case that the heating function needs to be enabled, the following Step 64 may be performed.

Step 64: determining whether or not to enable the heating function in accordance with the calculated wind temperature, and in the case that the heating function needs to be enabled, proceeding to Step 65.

Step 65: calculating a heating power value.

The MCU may compare the calculated wind temperature with the temperature threshold stored in the RAM at which the heating function needs to be enabled, so as to determine whether or not to adjust the heating power. In the case that it is unnecessary to adjust the heating power, the MCU may wait for the next calculation, and in the case that it is necessary to adjust the heating power, the following Step 66 may be performed.

Step 66: performing the heating power control in accordance with the calculation result.

The MCU may calculate the heating power value in accordance with the calculated wind temperature using a predetermined algorithm, and then adjust the heating power in accordance with the calculated heating power value.

The encryption module 22 may take charge of the initial authentication of the ultrasonic wind measurement device. In the case that the authentication has failed, the abnormality may occur for the entire ultrasonic wind measurement device, and in the case that the authentication has succeeded, the MCU may be allowed to read the initialization parameter, so as to prevent the data stored in the ultrasonic wind measurement from being stolen. In addition, the initialization parameters of the ultrasonic wind measurement device may further stored in the encryption module 22.

The parameters may be configured in an encryption chip separately, so as to facilitate the production.

### Second Embodiment

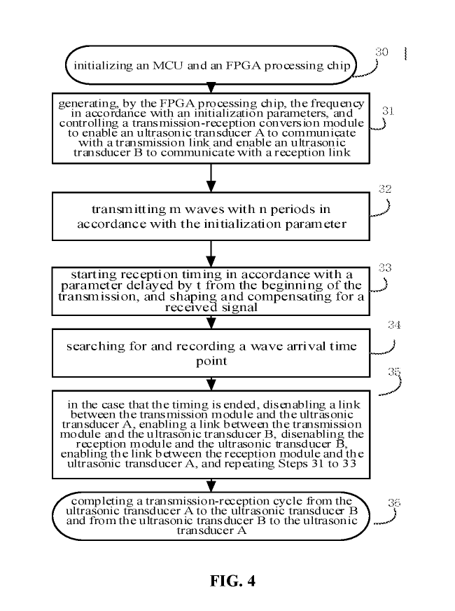

FIG. 3 is a flow chart of an ultrasonic wind measurement method according to the second embodiment of the present disclosure.

As shown in FIG. 3, the ultrasonic wind measurement method may be applied to the above-mentioned ultrasonic wind measurement device which includes an ultrasonic transducer group consisting of a first ultrasonic transducer, a second ultrasonic transducer and a third ultrasonic transducer. The ultrasonic wind measurement device may include: Step S1 of triggering any ultrasonic transducer in the ultrasonic transducer group to transmit a predetermined ultrasonic wave; Step S2 of controlling the predetermined ultrasonic wave to generate resonance in a wind measurement cavity receiving the ultrasonic transducer group, so as to enable any two ultrasonic transducers in the ultrasonic transducer group to be in a transmitting state and a receiving state within an identical time period respectively; Step S3 of acquiring a first direction transmission time period and a second direction transmission time period of the waves between the two ultrasonic transducers; and Step S4 of calculating a current wind speed and a current wind direction in accordance with the first direction transmission time period and the second direction transmission time period.

In Step S1, any ultrasonic transducer in the ultrasonic transducer group may be triggered to transmit the predetermined ultrasonic wave, and in the embodiments of the present disclosure, the term “trigger” refers to an action through which a first ultrasonic wave is generated by the ultrasonic transducer due to external excitation. For example, an FGPA processing chip may generate a predetermined frequency, and control the transmission module to excite one of the ultrasonic transducers so as to transmit the ultrasonic wave at the predetermined frequency in

Step S2. Upon the reception of the ultrasonic wave, the other ultrasonic transducer may reflect the ultrasonic wave. Through the circulation like this, it is able to generate the resonance. In Step S3, the time data about the transmission of the ultrasonic wave, i.e., a time period within which the ultrasonic wave is transmitted from the ultrasonic transducer A to the ultrasonic transducer B and then from the ultrasonic transducer B to the ultrasonic transducer A, may be acquired. The time period for the transmission of the ultrasonic wave may be calculated in accordance with a time point when the ultrasonic wave is transmitted by the ultrasonic transducer A, a time point when the ultrasonic wave is received by the ultrasonic transducer B, a time point when the ultrasonic wave is transmitted by the ultrasonic transducer B, and a time point when the ultrasonic wave is received by the ultrasonic transducer A. In Step S4, the current wind speed and the current wind direction may be calculated in accordance with the first direction transmission time period and the second direction transmission time period. Here, the first direction transmission time period may be an along-wind transmission time period, and the second direction transmission time period may be an against-wind transmission time period. The current wind speed and the current wind direction may be calculated in accordance with the along-wind transmission time period, the second direction transmission time period, and a difference between the along-wind transmission time period and the against-wind transmission time period. The calculation method has been described in the first embodiment of the present disclosure, and thus will not be particularly defined herein.

In a possible embodiment of the present disclosure, the step of triggering any ultrasonic transducer in the ultrasonic transducer group to transmit the predetermined ultrasonic wave includes: controlling the FPGA processing chip to generate a predetermined frequency in accordance with a predetermined parameter; and controlling a transmission module to transmit the predetermined ultrasonic wave in accordance with the predetermined frequency and the number of waves in the predetermined parameter.

In a possible embodiment of the present disclosure, the step of controlling the predetermined ultrasonic wave to generate the resonance in the wind measurement cavity receiving the ultrasonic transducer includes performing a link switching operation on the ultrasonic transducers in the ultrasonic transducer group in accordance with a predetermined control rule, so as to enable the ultrasonic transducer in the transmitting state to communicate with the transmission module and enable the ultrasonic transducer in the receiving state to communicate with the reception module.

In a possible embodiment of the present disclosure, the predetermined control rule includes: disenabling a link between the transmission module and the first ultrasonic transducer, enabling a link between the transmission module and the second ultrasonic transducer, disenabling a link between the reception module and the second ultrasonic transducer and opening a link between the reception module and the first ultrasonic transducer in the case that a time period for the link switching operation has reached a predetermined value; controlling the first ultrasonic transducer and the third ultrasonic transducer to perform wave transmission, and controlling the first ultrasonic transducer and the third ultrasonic transducer to perform the link switching operation between the reception module and the transmission module, after the wave transmission from the first ultrasonic transducer to the second ultrasonic transducer and the wave transmission from the second ultrasonic transducer to the first ultrasonic transducer have been completed; and controlling the second ultrasonic transducer and the third ultrasonic transducer to perform the wave transmission, and controlling the second ultrasonic transducer and the third ultrasonic transducer to perform the link switching operation between the reception module and the transmission module, after the wave transmission from the first ultrasonic transducer to the third ultrasonic transducer and the wave transmission from the third ultrasonic transducer to the first ultrasonic transducer have been completed.

The above is a preferred embodiment of the FPGA processing chip for the implementation of the ultrasonic resonance. The specific procedure will be described hereinafter.

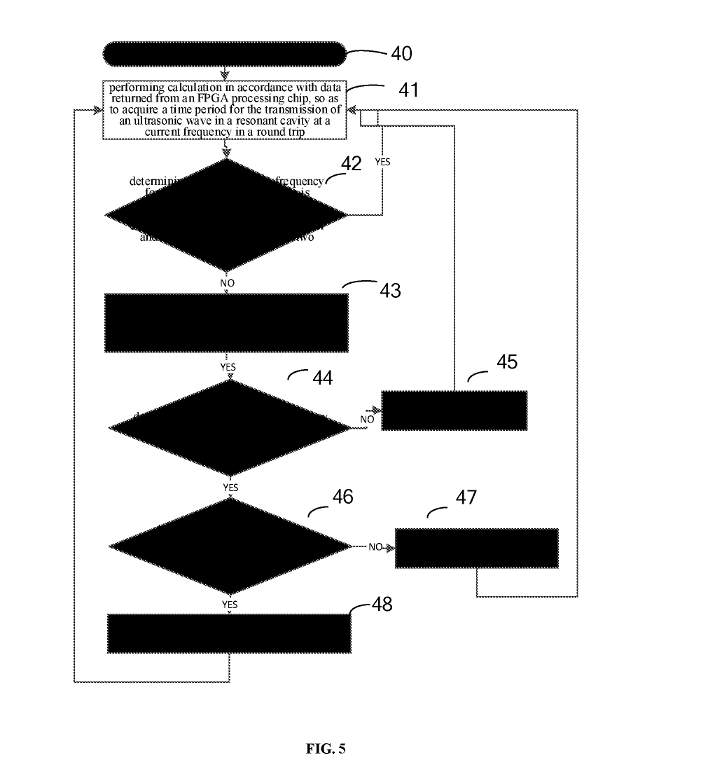

Referring to FIG. 4, the transmission and reception procedures performed by the ultrasonic wind measurement device include controlling, by the FPGA processing chip, the transmission-reception conversion module in accordance with the specific parameters, so that, for any two of the three ultrasonic transducers, one of them merely transmits the ultrasonic wave and the other merely receives the ultrasonic wave. After the initialization of the ultrasonic wind measurement device, the MCU and the FPGA processing chip have been initialized, and the relevant parameters have been configured. At this time, the FPGA processing chip starts to operate normally. The specific procedure may include the following steps.

Step 30: initializing the MCU and the FPGA processing chip.

Step 31: generating, by the FPGA processing chip, the frequency in accordance with a frequency-related parameter fin the initialization parameters, and controlling the transmission-reception conversion module to communicate with the ultrasonic transducer A to form a transmission link and communicate with the ultrasonic transducer B to form a reception link, and enabling a timer to be started for the transmission-reception conversion module.

Step 32: transmitting, by the FPGA processing chip, m waves in accordance with the number of the transmission waves in the initialization parameter.

Step 33: enabling, by the FPGA processing chip, a reception timing unit to be started and providing timing for a wave arrival time point in accordance with a time delay parameter delayed by t from the beginning of the transmission, and meanwhile shaping and compensating for the received signal.

Step 34: in the case that a reception time period has reached a predetermined value in the initialization parameter, stopping receiving the signal, and starting to search for and record the wave arrival time point.

Step 35: in the case that a value of the timer for the transmission-reception conversion module has reached a predetermined value for the initialized conversion, disenabling the link between the transmission module and the ultrasonic transducer A, enabling the link between the transmission module and the ultrasonic transducer B, disenabling the reception module and the ultrasonic transducer B, enabling the link between the reception module and the ultrasonic transducer A, and repeating Steps 31 to 33. At this time, the FPGA processing chip has finished the transmission-reception conversion between the ultrasonic transducers A and B, and acquired the wave transmission time periods of the ultrasonic waves from the ultrasonic transducer A to the ultrasonic transducer B and from the ultrasonic transducer B to the ultrasonic transducer A.

After the transmission of the ultrasonic waves from the ultrasonic transducer A to the ultrasonic transducer B and from the ultrasonic transducer B to the ultrasonic transducer A has been completed, the FPGA processing chip may control the transmission-reception conversion module to establish the link between the ultrasonic transducers A and C, i.e., to enable the transmission module to communicate with the ultrasonic transducer A and enable the reception module to communication with the ultrasonic transducer C. The above Steps 31 to 33 may be repeated, so as to acquire the wave transmission time period of the ultrasonic wave from the ultrasonic transducer A to the ultrasonic transducer C.

In the case that the value of the timer for the transmission-reception conversion module has reached the predetermined value for the initialized conversion, the link between the transmission module and the ultrasonic transducer A may be disenabled, the link between the transmission module and the ultrasonic transducer C may be enabled, the link between the reception module and the ultrasonic transducer C may be disenabled, the link between the reception module and the ultrasonic transducer A may be enabled, and the above Steps 31 to 33 may be repeated, so as to complete the transmission-reception conversion from the ultrasonic transducer C to the ultrasonic transducer A, and acquire the wave transmission time period from the ultrasonic transducer C to the ultrasonic transducer A.

Similarly, the wave transmission time period from the ultrasonic transducer B to the ultrasonic transducer C and from the ultrasonic transducer C to the ultrasonic transducer B may also be acquired.

The above-mentioned steps may be repeated, so as to perform the transmission-reception conversion continuously.

In a possible embodiment of the present disclosure, subsequent to the step of calculating the current wind speed and the current wind direction in accordance with the first direction transmission time period and the second direction transmission time period, the ultrasonic wind measurement method further includes: calculating a resonant frequency in accordance with a predetermined environmental compensation parameter and a distance between two planes in the wind measurement cavity; comparing the resonant frequency with a current frequency of the ultrasonic wave, so as to acquire a comparison result; in the case that the comparison result indicates that a difference between the resonant frequency and the current frequency of the ultrasonic wave is greater than a predetermined threshold, determining whether or not the resonant frequency falls within an operating frequency range of the ultrasonic transducer group; and in the case that the resonant frequency falls within the operating frequency range of the ultrasonic transducer group, adjusting a transmission frequency of the ultrasonic transducer group, so as to enable the ultrasonic wave to generate the resonance in the wind measurement cavity.

The above is a preferred scheme for the self-adaptive adjustment of the transmission frequency, and the specific implementation thereof will be described hereinafter.

FIG. 5 is a flow chart of a self-adaptive adjustment procedure of the transmission frequency in the ultrasonic wind measurement method according to the fourth embodiment of the present disclosure.

As shown in FIG. 5, the self-adaptive adjustment of the transmission frequency may include the following steps.

Step 40: completing the initialization.

Step 41: performing calculation in accordance with the data returned from the FPGA processing chip, so as to acquire a time period for the transmission of the ultrasonic wave in a resonant cavity at the current frequency in a round trip.

The MCU may continuously receive the data from the FPGA processing chip, and after it determines that the data from the FPGA processing chip relates to a complete transmission-reception conversion cycle, calculate the time period for the transmission of the ultrasonic wave at the current frequency in a round trip, the wind speed and the wind direction in accordance with the data and the basic principle of the ultrasonic wind measurement.

Step 42: determining whether or not a frequency for the generation of the resonance is identical to the current frequency in accordance with the current environmental compensation parameter and an actual distance between two parallel planes.

The MCU may calculate the frequency for the generation of the resonance in accordance with the current environmental compensation parameter and the actual distance between the two parallel planes, and compare the resonant frequency with the current frequency. In the case that the resonant frequency is identical to the current frequency, it is unnecessary to recalibrate the resonant frequency, and in the case that the resonant frequency is not identical to the current frequency, the following Step 43 may be performed.

Step 43: calculating the frequency for the generation of the resonance in accordance with the current environmental compensation parameter and the actual distance between the two parallel planes.

Step 44: determining whether or not a frequency difference is greater than a predetermined threshold, in the case that the frequency difference is not greater than the predetermined threshold, proceeding to Step 45, and in the case that the frequency difference is greater than the predetermined threshold, proceeding to Step 46.

The MCU may determine whether or not a difference between the resonant frequency and the current frequency is greater than the predetermined threshold stored in the RAM. In the case that the difference is equal to or smaller than the predetermined threshold, it is unnecessary to adjust the resonant frequency, and in the case that the difference is greater than the predetermined threshold, the following Step 48 may be performed.

Step 45: in the case that the frequency difference is not greater than the predetermined threshold, not adjusting the resonant frequency.

Step 46: determining whether or not the frequency to be adjusted is beyond the operating frequency range of the ultrasonic transducer.

Step 47: in the case that the frequency to be adjusted is within the operating frequency range of the ultrasonic transducer, adjusting the resonant frequency.

The MCU may determine whether or not the calculated resonant frequency is within the operating frequency range of the ultrasonic transducer. In the case that the resonant frequency is not within the operating frequency range of the ultrasonic transducer, the resonant frequency may be adjusted to a maximum operating frequency of the ultrasonic transducer. In the case that the resonant frequency is within the operating frequency range of the ultrasonic transducer, the transmission frequency of the ultrasonic transducer may be adjusted in such a manner as to generate the resonance at a current condition.

Step 48: in the case that the frequency to be adjusted is beyond the operating frequency range of the ultrasonic transducer, adjusting the resonant frequency to the maximum operating frequency of the ultrasonic transducer.

According to the embodiments of the present disclosure, the ultrasonic wave may generate resonance in the wind measurement cavity due to transmission characteristics and a reflection principle thereof, so as to adjust the transmission power of the ultrasonic transducer. In addition, the resonant frequency may be adjusted in a self-adaptive manner using a self-adaptive algorithm, so as to enable the ultrasonic wind measurement device to operate in a resonant state in different environments.

The above are merely the preferred embodiments of the present disclosure. Obviously, a person skilled in the art may make further modifications and improvements without departing from the spirit of the present disclosure, and these modifications and improvements shall also fall within the scope of the present disclosure.

What is claimed is:

1. An ultrasonic wind measurement device, comprising:
an ultrasonic transducer group consisting of a first ultrasonic transducer, a second ultrasonic transducer and a third ultrasonic transducer and configured to generate ultrasonic resonance in a wind measurement cavity receiving the ultrasonic transducer group;
a transmission module configured to drive any ultrasonic transducer in the ultrasonic transducer group to transmit an ultrasonic wave;
a transmission-reception conversion module configured to perform a link switching operation on the ultrasonic transducer group in accordance with a predetermined control command, so as to enable the ultrasonic transducer in a transmitting state to communicate with the transmission module and enable the ultrasonic transducer in a receiving state to communicate with a reception module; the reception module configured to receive the ultrasonic wave;
a collection module configured to acquire original data about the transmission and reception of the ultrasonic wave;
a Field Programmable Gate Array (FPGA) processing chip configured to generate a first driving signal for driving the transmission module to generate the ultrasonic wave, and to process the original data so as to acquire time data; and
a processor control module configured to acquire an initialization parameter, and acquire a current wind speed and a current wind direction through calculation in accordance with the time data.

2. The ultrasonic wind measurement device according to claim 1, wherein the predetermined control command comprises:
a command for disenabling a link between the transmission module and the first ultrasonic transducer, enabling a link between the transmission module and the second ultrasonic transducer, disenabling a link between the reception module and the second ultrasonic transducer and enabling a link between the reception module and the first ultrasonic transducer in the case that a time period for the link switching operation has reached a predetermined value;
a command for controlling the first ultrasonic transducer and the third ultrasonic transducer to perform wave transmission, and controlling the first ultrasonic transducer and the third ultrasonic transducer to perform the link switching operation between the reception module and the transmission module, after the wave transmission from the first ultrasonic transducer to the second ultrasonic transducer and the wave transmission from the second ultrasonic transducer to the first ultrasonic transducer have been completed; and
a command for controlling the second ultrasonic transducer and the third ultrasonic transducer to perform the wave transmission, and controlling the second ultrasonic transducer and the third ultrasonic transducer to perform the link switching operation between the reception module and the transmission module, after the wave transmission from the first ultrasonic transducer to the third ultrasonic transducer and the wave transmission from the third ultrasonic transducer to the first ultrasonic transducer have been completed.

3. The ultrasonic wind measurement device according to claim 1, further comprising a self-adaptive heating module configured to compare a current ambient temperature with a predetermined temperature to acquire a comparison result, and adjusting heating power of a corresponding heating device in accordance with the comparison result.

4. The ultrasonic wind measurement device according to claim 1, further comprising an encryption module configured to initially authenticate the ultrasonic wind measurement device, and after the authentication has succeeded, control the processor control module to read the initialization parameter.

5. The ultrasonic wind measurement device according to claim 1, wherein the processor control module is further configured to:
calculate a resonant frequency in accordance with a predetermined environmental compensation parameter and a distance between two planes in the wind measurement cavity;
compare the resonant frequency with a current frequency of the ultrasonic wave, so as to acquire a comparison result;
in the case that the comparison result indicates that a difference between the resonant frequency and the current frequency of the ultrasonic wave is greater than a predetermined threshold, determine whether or not the resonant frequency falls within an operating frequency range of the ultrasonic transducer group; and
in the case that the resonant frequency falls within the operating frequency range of the ultrasonic transducer group, adjust a transmission frequency of the ultrasonic transducer group, so as to enable the ultrasonic wave to generate the resonance in the wind measurement cavity.

6. An ultrasonic wind measurement method for an ultrasonic wind measurement device which comprises an ultrasonic transducer group consisting of a first ultrasonic transducer, a second ultrasonic transducer and a third ultrasonic transducer, the ultrasonic wind measurement method comprising steps of:
triggering any ultrasonic transducer in the ultrasonic transducer group to transmit a predetermined ultrasonic wave;
controlling the predetermined ultrasonic wave to generate resonance in a wind measurement cavity receiving the ultrasonic transducer group, so as to enable any two ultrasonic transducers in the ultrasonic transducer group to be in a transmitting state and a receiving state within an identical time period respectively;
acquiring a first direction transmission time period and a second direction transmission time period of the waves between the two ultrasonic transducers; and
calculating a current wind speed and a current wind direction in accordance with the first direction transmission time period and the second direction transmission time period.

7. The ultrasonic wind measurement method according to claim 6, wherein the step of triggering any ultrasonic transducer in the ultrasonic transducer group to transmit the predetermined ultrasonic wave comprises:
controlling an FPGA processing chip to generate a predetermined frequency in accordance with a predetermined parameter; and
controlling a transmission module to transmit the predetermined ultrasonic wave in accordance with the predetermined frequency and the number of waves in the predetermined parameter.

8. The ultrasonic wind measurement method according to claim 6, wherein the step of controlling the predetermined ultrasonic wave to generate the resonance in the wind measurement cavity receiving the ultrasonic transducer comprises performing a link switching operation on the ultrasonic transducers in the ultrasonic transducer group in accordance with a predetermined control rule, so as to enable the ultrasonic transducer in the transmitting state to communicate with the transmission module and enable the ultrasonic transducer in the receiving state to communicate with the reception module.

9. The ultrasonic wind measurement method according to claim 8, wherein the predetermined control rule comprises:
disenabling a link between the transmission module and the first ultrasonic transducer, enabling a link between the transmission module and the second ultrasonic transducer, disenabling a link between the reception module and the second ultrasonic transducer and enabling a link between the reception module and the first ultrasonic transducer in the case that a time period for the link switching operation has reached a predetermined value;
controlling the first ultrasonic transducer and the third ultrasonic transducer to perform wave transmission, and controlling the first ultrasonic transducer and the third ultrasonic transducer to perform the link switching operation between the reception module and the transmission module, after the wave transmission from the first ultrasonic transducer to the second ultrasonic transducer and the wave transmission from the second ultrasonic transducer to the first ultrasonic transducer have been completed; and
controlling the second ultrasonic transducer and the third ultrasonic transducer to perform the wave transmission, and controlling the second ultrasonic transducer and the third ultrasonic transducer to perform the link switching operation between the reception module and the transmission module, after the wave transmission from the first ultrasonic transducer to the third ultrasonic transducer and the wave transmission from the third ultrasonic transducer to the first ultrasonic transducer have been completed.

10. The ultrasonic wind measurement method according to claim 6, wherein subsequent to the step of calculating the current wind speed and the current wind direction in accordance with the first direction transmission time period and the second direction transmission time period, the ultrasonic wind measurement method further comprises:
calculating a resonant frequency in accordance with a predetermined environmental compensation parameter and a distance between two planes in the wind measurement cavity;
comparing the resonant frequency with a current frequency of the ultrasonic wave, so as to acquire a comparison result;
in the case that the comparison result indicates that a difference between the resonant frequency and the current frequency of the ultrasonic wave is greater than a predetermined threshold, determining whether or not the resonant frequency falls within an operating frequency range of the ultrasonic transducer group; and
in the case that the resonant frequency falls within the operating frequency range of the ultrasonic transducer group, adjusting a transmission frequency of the ultrasonic transducer group, so as to enable the ultrasonic wave to generate the resonance in the wind measurement cavity.
